(19) United States
(12) Patent Application Publication
(10) Pub. No.: US 2025/0225199 A1
(43) Pub. Date: Jul. 10, 2025

(54) SYSTEM AND METHOD FOR MATRIX MULTIPLICATION

(71) Applicant: HUAWEI TECHNOLOGIES CO., LTD., Shenzhen (CN)

(72) Inventors: Vitaly Vitalyevich Slobodskoy, Moscow (RU); Roman Alekseevich Kurmaev, Moscow (RU)

(73) Assignee: HUAWEI TECHNOLOGIES CO., LTD., Shenzhen (CN)

(21) Appl. No.: 19/090,058

(22) Filed: Mar. 25, 2025

Related U.S. Application Data
(63) Continuation of application No. PCT/RU2022/000293, filed on Sep. 27, 2022.

(51) Int. Cl. G06F 17/16

(52) U.S. Cl. CPC G06F 17/16

(57) ABSTRACT

Embodiments of the present application provide a system for matrix multiplication. According to the proposed system, a residue number system (RNS) is configured to enable a multi-size support in matrix multiplication hardware acceleration. A forward conversion unit and a reverse conversion unit enable the multi-size support under a dedicated control signal. An extension for the forward conversion unit of the RNS allows to interpret a 64-bit input value differently depending on a control signal value, and performs modulo reduction operations for a single 64-bit value, or two 32-bit values or four 16-bit values. An extension for the reverse conversion unit of the RNS allows to reconstruct different size types of values using efficient hierarchical controlled accumulation. As a result, the proposed system for matrix multiplication provides the multi-size support for the matrix multiplication without increasing hardware area and implements less power consumption.

### CROSS-REFERENCE TO RELATED APPLICATIONS

This application is a continuation of International Application No. PCT/RU2022/000293, filed on Sep. 27, 2022, the disclosure of which is hereby incorporated by reference in its entirety.

### TECHNICAL FIELD

Embodiments of the present invention relate to the field of matrix multiplication technologies, and more specifically, to a system and a method for matrix multiplication.

### BACKGROUND

Dedicated matrix multiplication acceleration is widely used in high performance computing (HPC) and artificial intelligence (AI), but these two area have different requirements for size types—integer32 (int32)/integer64 (int64) is mainly used for the HPC, while int8/int16 is commonly used for the AI. For hardware manufacturers, this provides two strategic directions-creating special accelerators for the AI and HPC or minimizing development costs by creating accelerators suitable for the two areas. A common way to support different size types in the hardware is for each integer length (such as AMD® CDNA™ Matrix Core Technology) to implement a separate multiply accumulator (MAC) unit. However, due to partially unused hardware and higher power consumption, this usually makes a final product less competitive compared with the matrix multiplication accelerator dedicated for a particular area.

### SUMMARY

Embodiments of the present application provide a system and a method for matrix multiplication, which provide a reconfigurable multi-size matrix multiplication support.

According to a first aspect, provided is a system for matrix multiplication, including a forward conversion unit, a modular arithmetic unit and a reverse conversion unit,
where the forward conversion unit is configured to:
receive binary input values and a control signal, where the control signal is configured to indicate a size type of the input values;
make a forward conversion on the input values according to the size type to obtain converted values of the input values, where a converted value of each input value is a set of residues of the input value in a residue number system (RNS); and
output the converted values to the modular arithmetic unit;
where the modular arithmetic unit is configured to:
receive the converted values from the forward conversion unit;
perform a modular arithmetic operation on the converted values according to a set of moduli of the RNS to obtain operation results; and
output the operation results to the reverse conversion unit;
where the reverse conversion unit is configured to:
receive the operation results and the control signal; and
make a reverse conversion on the operation results according to the control signal to obtain the binary output values, where the binary output values and the binary input values have the same size type.

As an example, the size type includes one of the following types: a 64-bit type, a 32-bit type or a 16-bit type.

In addition, as an example, the reverse conversion unit is configured to make a reverse conversion on the operation results according to the control signal and Chinese Remainder Theorem (CRT) to obtain the binary output values. Optional, the CRT also can be replaced with extended CRT (EXCRT) or Mixed-Radix Conversion (MRC).

According to the system proposed by the present application, a residue number system (RNS) is configured to enable a multi-size support in matrix multiplication hardware acceleration. The forward conversion unit and the reverse conversion unit enables the multi-size support under a dedicated control signal. An extension for the forward conversion unit of the RNS allows to interpret a 64-bit input value differently depending on a control signal value, and perform modulo reduction operations for a single 64-bit value, or two 32-bit values or four 16-bit values. An extension for the reverse conversion unit of the RNS based on Chinese Remainder Theorem (CRT) (merely an example) allows to reconstruct different size types of values using efficient hierarchical controlled accumulation. As a result, the proposed system for the matrix multiplication provides the multi-size support for the matrix multiplication without increasing hardware area and implements less power consumption.

In some implementation manners, the forward conversion unit includes M multiplexers which corresponds to M modulo reduction unit groups, where the system supports value processing of multiple size types, the multiple size types include a first size type and a second size type, and the first size type corresponds to a maximum size that supported by the system;
in the case that the control signal indicates the first size type, M multiplexers obtain each of the binary input values as an input of the corresponding modulo reduction unit groups respectively;
or
in the case that the control signal indicates the second size type, the M multiplexers obtain part bits of each of the binary input values as an input of the corresponding modulo reduction unit groups respectively, M is an integer greater than or equal to 2.

In some implementation manners, each of the M modulo reduction unit groups comprises P modulo reduction units, P is an integer greater than or equal to 2.

As an example, M=4, P=4, that is, the forward conversion units includes four modulo reduction unit groups, and each of four modulo reduction unit groups corresponding to the four multiplexers includes four modulo reduction units respectively.

In addition, M·P is the number of moduli contained in a modulo set corresponding to the RNS of the proposed application.

In some implementation manners, where the forward conversion unit includes four multiplexers and four modulo reduction unit groups, the four multiplexers are in one-to-one correspondence with the four modulo reduction unit groups; each of the four modulo reduction unit groups includes four modulo reduction units, and the four modulo reduction unit groups comprise sixteen modulo reduction units in all, where the sixteen modulo reduction units are in one-to-one correspondence with sixteen moduli of the RNS;
where the four multiplexers are specifically configured to:
receive the control signal;
determine the size type of the input values as a 64-bit type in case of a value of the control signal being equal to a first value;
obtain the input values, and output each input value to each of the sixteen modulo reduction units; and
where the sixteen modulo reduction units are specifically configured to:
perform a reduction operation on each input value to obtain sixteen converted values based on their corresponding moduli respectively, where each of the sixteen modulo reduction units obtains one converted value of the sixteen converted values.

According to this embodiment, an extension for a RNS forward conversion unit allows to interpret each 64-bit input value as a single 64-bit value based on a control signal value, and the forward conversion unit performs a forward conversion on the input 64-bit value to obtain residues of the input 64-bit value.

It should be noted that, sixteen is used as an example in this embodiment as it is easy to be divided by four, and it actually can be any number other than sixteen of the total modulo used. Furthermore, there is no strict requirement for having the same number of moduli between different groups, for example, there may be three, four, five or other number of moduli in a group. The requirements only relate to the multiplication value of the modulo which is supposed to be higher than a binary range covered.

In some implementation manners, where the forward conversion unit includes four multiplexers and four modulo reduction unit groups, the four multiplexers are in one-to-one correspondence with the four modulo reduction unit groups; each of the four modulo reduction unit groups includes the four modulo reduction units, and the four modulo reduction unit groups comprise the sixteen modulo reduction units in all, where the sixteen modulo reduction units are in one-to-one correspondence with sixteen moduli of the RNS;
where the four multiplexers are specifically configured to:
receive the control signal;
determine the size type of the input values as a 32-bit type in case of a value of the control signal being equal to a second value;
where a first multiplexer and a third multiplexer of the four multiplexers obtain low 32 bits of each input value respectively, the first multiplexer outputs the low 32 bits to a corresponding first modulo reduction unit group, and the third multiplexer outputs the low 32 bits to a corresponding third modulo reduction unit group;
where a second multiplexer and a fourth multiplexer of the four multiplexer obtain high 32 bits of each input value respectively, the second multiplexer outputs the high 32 bits to a corresponding second modulo reduction unit group, and the fourth multiplexer outputs the high 32 bits to a corresponding fourth modulo reduction unit group; and
where the four modulo reduction units are specifically configured as follows:
the first modulo reduction unit group and the third modulo reduction unit group perform a modulo reduction operation on the low 32 bits to obtain four converted values, respectively, based on four moduli corresponding to the four modulo reduction units contained in each of the first modulo reduction unit group and the third modulo reduction unit group, respectively; and
the second modulo reduction unit group and the fourth modulo reduction unit group perform a modulo reduction operation on the high 32 bits to obtain four converted values, respectively, based on four moduli corresponding to the four modulo reduction units contained in each of the second modulo reduction unit group and the fourth modulo reduction unit group, respectively.

According to this embodiment, the extension for the RNS forward conversion unit allows to interpret each 64-bit input value as two 32-bit values based on the control signal value, and the forward conversion unit performs the forward conversion on the two 32-bit values, respectively, to obtain the residues of the two 32-bit values.

In some implementation manners, where the forward conversion unit includes four multiplexers and four modulo reduction unit groups, the four multiplexers are in one-to-one correspondence with the four modulo reduction unit groups; each of the four modulo reduction unit groups includes the four modulo reduction units, and the four modulo reduction unit groups comprise the sixteen modulo reduction units in all, where the sixteen modulo reduction units are in one-to-one correspondence with sixteen moduli of the RNS;
where each of the four multiplexers is specifically configured to:
receive the control signal;
determine the size type of the input values as a 16-bit type in case of a value of the control signal being equal to a third value;
obtain one of four segments constituting each input value, and output the obtained segment to a corresponding modulo reduction unit group, respectively; and
where each of the modulo reduction unit groups is specifically configured to:
perform a modulo reduction operation on the corresponding segment, respectively, based on four moduli corresponding to the four modulo reduction units contained in each of the four modulo reduction unit groups, to obtain four converted values, respectively.

According to this embodiment, the extension for the RNS forward conversion unit allows to interpret each 64-bit input value as four 16-bit values based on the control signal value, and the forward conversion unit performs the forward conversion on the four 16-bit values respectively, to obtain the residues of the four 16-bit values.

In some implementation manners, where the modular arithmetic unit includes sixteen multiply accumulator (MAC) units, the sixteen MAC units are in one-to-one correspondence with the sixteen moduli, and the sixteen MAC units are in one-to-one correspondence with the sixteen modulo reduction units;
where each of the sixteen MAC units is specifically configured to:
receive converted values from a corresponding modulo reduction unit, and perform modulo multiplication and a modulo accumulation operation on each converted value based on a corresponding modulo to obtain a corresponding operation result; and
where when performing the modulo multiplication and the modulo accumulation operation, the sixteen MAC units form different groups in the following way:
the sixteen MAC units form one group in case of the size type of the input values being 64-bit type, where the group is configured to perform the modulo multiplication and the modulo accumulation operation on the sixteen converted values from the sixteen modulo reduction units, and output sixteen operation results corresponding to the sixteen converted values; or
the sixteen MAC units form two groups in case of the size type of the input values being 32-bit type, where each of the two groups includes eight MAC units, one of the two groups is configured to perform the modulo multiplication and the modulo accumulation operation on eight converted values and output eight operation results corresponding to the eight converted values, and the eight converted values comprise the four converted values from the first modulo reduction unit and the third modulo reduction unit, respectively; where the other of the two groups is configured to perform the modulo multiplication and the modulo accumulation operation on the other eight converted values and output eight operation results corresponding to the other eight converted values, and the other eight converted values comprise the four converted values from the second modulo reduction unit and the fourth modulo reduction unit, respectively; or
the sixteen MAC units form four groups in case of the size type of the input values being 16-bit type, where each of the four groups includes four MAC units, the four groups are in one-to-one correspondence with the four modulo reduction unit groups, and each of the four groups is configured to perform the modulo multiplication and the modulo accumulation operation on the four converted values from the four modulo reduction units contained in the corresponding modulo reduction group and output four operation results corresponding to the four converted values, respectively.

In some implementation manners, where the reverse conversion unit supports reverse conversion of multiple size types, and the multiple size types further include a third size type, and the third size type corresponds to the minimum size supported by the system;
the reverse conversion unit includes a first multiplexer set containing M P multiplexers and a second multiplexer set containing V multiplexers, the M P multiplexers are in one-to-one correspondence with M P operation results from the modular arithmetic unit respectively, and the V multiplexers are used for outputting the binary output values;
in the case that the value of the control signal indicates the first size type, each of the V multiplexers obtains a segment of a modulo reduction result which is related to all of the M P operation results as an output respectively, and V segments corresponding to the V multiplexers reconstruct an binary output value corresponding to the first size type;
or,
in the case that the value of the control signal indicates the third size type, each of the V multiplexers obtains an modulo reduction result which is related to P operation results of the M P operation results as an output, and the modulo reduction result obtained by each of the multiplexers reconstruct an binary output value corresponding to the third size type;
or,
in the case that the value of the control signal indicates the second size type, each of the V multiplexers obtains a modulo reduction result which is related to L operation results of the M P operation results as an output, and the modulo reduction result obtained by each of the V multiplexers is a segment of an binary output corresponding to the second size type, L is an integral multiple of P.

As an example, M=4, P=4, and V=4, and the first multiplexer set includes 16 multiplexers, and the second multiplexer set includes 4 multiplexer.

In some implementation manners, where the first multiplexer set includes sixteen multiplexers, and the sixteen multiplexers are in one-to-one correspondence with the sixteen MAC units, where the sixteen multiplexers are four multiplexer groups, and each of the four multiplexer groups includes the four multiplexers;
where the sixteen multiplexers contained in the first multiplexer set are respectively configured to receive the control signal, and return a constant value from three pre-computed constant values according to the control signal, respectively;
where the reverse conversion unit further includes a multiplier set, the multiplier set includes sixteen multipliers, the sixteen multipliers are in one-to-one correspondence with the sixteen multiplexers contained in the first multiplexer set, and the sixteen multipliers are in one-to-one correspondence with the sixteen MAC units; where each of the sixteen multipliers is configured to perform a multiplication operation on an output of a corresponding multiplier of the sixteen multipliers and an output of a corresponding MAC unit of the sixteen MAC units, and output a corresponding operation result;
where the reverse conversion unit further includes three adder sets, a first adder set of the three adder sets includes four adders, where the four adders are in one-to-one correspondence with the four multiplexer groups, and an input of each adder of the four adders includes outputs of four multipliers corresponding to the four multiplexers in the corresponding multiplexer group;
a second adder set of the three adder sets includes two adders, where a first adder of the two adders is configured to receive an output of the first adder and an output of the second adder contained in the first adder set, and a second adder of the two adders is configured to receive an output of the third adder and an output of the fourth adder contained in the first adder set;
a third adder set of the three adder sets includes one adder, where the adder is configured to receive outputs of the two adders contained in the second adder set;
where the second multiplexer set includes the four multiplexers, and an input of each multiplexer contained in the four multiplexers is obtained by performing the modulo reduction operation on outputs of the four adders contained in the first adder set, an input of each multiplexer contained in the four multiplexers is obtained by performing the modulo reduction operation on the outputs of the two adders contained in the second adder set, or an input of each multiplexer contained in the four multiplexers is obtained by performing the modulo reduction operation on an output of the adder contained in the third adder set; and
where the four multiplexers contained in the second multiplexer set are configured to receive the control signal and determine a corresponding output value according to the control signal.

In some implementation manners, where the pre-computed three constant values of a i-th multiplexer of the sixteen multiplexers contained in the first multiplexer set comprise: Mₘ_{ᵢ}⁶⁴|M⁻¹|ₘ_{ᵢ}⁶⁴, Mₘ_{ᵢ}³²|M⁻¹|ₘ_{ᵢ}³² and Mₘ_{ᵢ}¹⁶|M⁻¹|ₘ_{ᵢ}¹⁶, where 1≤i≤16 and i is a positive integer;
where the i-th multiplexer is specifically configured to:
output Mₘ_{ᵢ}⁶⁴|M⁻¹|ₘ_{ᵢ}⁶⁴ in case of the value of the control signal being equal to the first value;
output Mₘ_{ᵢ}³²|M⁻¹ₘ_{ᵢ}³² in case of the value of the control signal being equal to the second value; and
output Mₘ_{ᵢ}¹⁶|M⁻¹|ₘ_{ᵢ}¹⁶ in case of the value of the control signal being equal to the third value.

In some implementation manners, a set of the sixteen moduli of the RNS is {m₁, m₂, . . . , m₁₆}, where the sixteen moduli meet the following criteria:

$${\prod }_{i = 1}^{16} {m}_{i} > {2}^{128} ; \qquad ( 1 )$$

$${m}_{1} \times {m}_{5} \times {m}_{9} \times {m}_{13} \times {m}_{3} \times {m}_{7} \times {m}_{11} \times {m}_{15} > {2}^{64} ; \qquad ( 2 )$$

$${m}_{2} \times {m}_{6} \times {m}_{10} \times {m}_{14} \times {m}_{4} \times {m}_{8} \times {m}_{12} \times {m}_{16} > {2}^{64} ; \qquad ( 3 )$$

$${m}_{1} \times {m}_{5} \times {m}_{9} \times {m}_{13} > {2}^{32} ; \qquad ( 4 )$$

$${m}_{2} \times {m}_{6} \times {m}_{10} \times {m}_{14} > {2}^{32} ; \qquad ( 5 )$$

$${m}_{3} \times {m}_{7} \times {m}_{11} \times {m}_{15} > {2}^{32} ; \qquad ( 6 )$$

$${m}_{4} \times {m}_{8} \times {m}_{12} \times {m}_{16} > {2}^{32} . \qquad ( 7 )$$

In some implementation manners, where the four modulo reduction unit groups are in one-to-one correspondence with four modulo groups consisting of the sixteen moduli, and the four modulo groups are: {m₁, m₅, m₉, m₁₃}, {m₂, m₆, m₁₀, m₁₄}, {m₃, m₇, m₁₁, m₁₅}, and {m₄, m₈, m₁₂, m₁₆}, where {m₁, m₂, . . . , m₁₆}={512, 511, 509, 489, 487, 485, 481, 479, 473, 467, 431, 167, 151, 139, 137, 131}.

It should be noted that, values of the sixteen moduli are taken merely as an example, and the criteria the sixteen modulo must meet has been listed as above.

In some implementation manners, where the four multiplexers contained in the second multiplexer set are specifically configured as follows:
in case of the value of the control signal being equal to the first value, an output of each of the four multiplexers is an operation result by performing a modulo reduction operation s % M⁶⁴ on the output of the adder contained in the third adder set, where s is the output of the adder contained in the third adder set, M⁶⁴=Πᵢ₌₁¹⁶ mᵢ, and outputs of the four multiplexers are four segments of the operation result, respectively, where the four segments are o⁶⁴[15:0], o⁶⁴[31:16], o⁶⁴[47:32], o⁶⁴[63:48].

In some implementation manners, where the four multiplexers contained in the second multiplexer set are specifically configured as follows:
in case of the value of the control signal being equal to the second value, outputs of a first multiplexer and a second multiplexer of the four multiplexers are operation results by performing a modulo reduction operation t₁% M₁³² on an output of the first adder contained in the second adder set, where t₁ is the output of the first adder contained in the second adder set, M₁³²=m₁×m₂×m₉×m₁₃×m₃×m₇×m₁₁×m₁₅, and the outputs of the first multiplexer and the second multiplexer are two segments of the operation results, respectively, where the two segments are o₁³² [15:0], o₁³² [31:16]; and outputs of a third multiplexer and a forth multiplexer of the four multiplexers are operation results by performing a modulo reduction operation t₂% M₂³² on an output of the second adder contained in the second adder set, where t₂ is the output of the second adder contained in the second adder set, M₂³²=m₂×m₆×m₁₀×m₁₄×m₄×m₈×m₁₂×m₁₆, and the outputs of the third multiplexer and the fourth multiplexer are two segments of the operation results, where the two segments are o₂³² [15:0], o₂³² [63:16].

In some implementation manners, where the four multiplexers comprised in the second multiplexer set are specifically configured to:
in case of the value of the control signal equals to the third value, an output of the j-th multiplexer of the four multiplexer is an operation result by performing a modulo reduction operation pⱼ% Mⱼ¹⁶ on an output of the j-th adder comprised in the first adder set, where pⱼ is the output of the j-th adder, M₁¹⁶=m₁×m₅×m₈×m₁₃, M₂¹⁶=m₂×m₆×m₁₀×m₁₄, M₃¹⁶ m₃×m₇×m₁₁×m₁₅, M₄¹⁶=m₄×m₈×m₁₂×m₁₆, 1≤j≤4 and j is an integer, and outputs of the four multiplexer are respectively o₁¹⁶, o₂¹⁶, o₃¹⁶, o₄¹⁶.

According to a second aspect, provided is a method for matrix multiplication, including:
receiving binary input values and a control signal, where the control signal is configured to indicate a size type of element values of two matrices to be performed matrix multiplication;
obtaining the element values according to the input values and the control signal;
making a forward conversion on the element values to obtain converted values of the element values, where a converted value of each element value is a set of residues of the element value in a residue number system (RNS);
performing a modular arithmetic operation on the converted values according to a set of moduli of the RNS to obtain operation results, where the modular arithmetic operation includes the matrix multiplication; and
making a reverse conversion on the operation results according to the control signal to obtain binary output values, where the output values and the input values have the same size type, and an output matrix will consist of the output values.

In some implementation manners, where the obtaining the element values according to the input values and the control signal further includes:
obtaining the element values by determining each input value as a single 64-bit element value in case of a value of the control signal being equal to a first value;
obtaining the element values by splitting each input value into two 32-bit element values in case of the value of the control signal being equal to a second value; or
obtaining the element values by splitting each input value into four 16-bit element values in case of the value of the control signal being equal to a third value.

In some implementation manners, where a set of sixteen moduli of the RNS is {m₁, m₂, . . . , M₁₆}, and the sixteen moduli meet the following criteria:

$${\prod }_{i = 1}^{16} {m}_{i} > {2}^{128} ; \qquad ( 1 )$$

$${m}_{1} \times {m}_{5} \times {m}_{9} \times {m}_{13} \times {m}_{3} \times {m}_{7} \times {m}_{11} \times {m}_{15} > {2}^{64} ; \qquad ( 2 )$$

$${m}_{2} \times {m}_{6} \times {m}_{10} \times {m}_{14} \times {m}_{4} \times {m}_{8} \times {m}_{12} \times {m}_{16} > {2}^{64} ; \qquad ( 3 )$$

$${m}_{1} \times {m}_{5} \times {m}_{9} \times {m}_{13} > {2}^{32} ; \qquad ( 4 )$$

$${m}_{2} \times {m}_{6} \times {m}_{10} \times {m}_{14} > {2}^{32} ; \qquad ( 5 )$$

$${m}_{3} \times {m}_{7} \times {m}_{11} \times {m}_{15} > {2}^{32} ; \qquad ( 6 )$$

$${m}_{4} \times {m}_{8} \times {m}_{12} \times {m}_{16} > {2}^{32} . \qquad ( 7 )$$

According to a third aspect, a computing device is provided. The computing device has a function of implementing the method in the second aspect and any possible implementation manners of the second aspect. The function may be implemented by using a hardware. The hardware or the software includes one or more units corresponding to the foregoing function. Optional, the computing device is a chip or chip system.

According to a forth aspect, a chip is provided. The chip includes a plurality of circuits, where the plurality of circuits are configured to have functions of units included in a system according to the first aspect and any possible implementation manners of the first aspect.

### DESCRIPTION OF DRAWINGS

One or more embodiments are exemplarily described by corresponding accompanying drawings, and these exemplary illustrations and accompanying drawings constitute no limitation on the embodiments. Elements with the same reference numerals in the accompanying drawings are illustrated as similar elements, and the drawings are not limiting to scale, in which:

FIG. 1 is a schematic block diagram of a system for multi-size support matrix multiplication according to the present application.

FIG. 2 is an example of a RNS basic process.

FIG. 3 is a schematic structural diagram of a forward conversion unit according to the present application.

FIG. 4 is an example of forward conversion unit of the present application.

FIG. 5 is a schematic structural diagram of a modular arithmetic unit according to the present application.

FIG. 6 is a schematic structural diagram of a reverse conversion according to the present application.

FIG. 7 is a schematic diagram of a method for matrix multiplication according to the present application.

### DESCRIPTION OF EMBODIMENTS

In order to understand features and technical contents of embodiments of the present disclosure in detail, implementations of the embodiments of the present disclosure will be described in detail below with reference to the accompanying drawings, and the attached drawings are only for reference and illustration purposes, and are not intended to limit the embodiments of the present disclosure. In the following technical descriptions, for ease of explanation, numerous details are set forth to provide a thorough understanding of the disclosed embodiments. One or more embodiments, however, may be practiced without these details. In other cases, well-known structures and apparatuses may be shown simplified in order to simplify the drawings.

### 1. Residue Number System (RNS)

A RNS is defined by a set of k moduli {m₁, m₂, . . . , mₖ} called moduli. The k moduli are generally supposed to be pairwise coprime, i.e.,GCD(mᵢ, mⱼ)=1, i, j∈[1, k], i≠j. Let M be a product of all mᵢ: M=Πᵢ₌₁^{k} mᵢ, then an integer x in a range of [0, M−1] is represented in the RNS by a set of its residues x→{x₁, x₂, . . . , xₖ} under Euclidean division by the moduli; that is,

$${x}_{i} = {\vert {\sum }_{i = 1}^{k} {x}_{i} {M}_{i} {M}_{i}^{- 1} \vert}_{M} , {M}_{i} = \frac{M}{{m}_{i}} .$$

One of the greatest RNS feature is that addition and multiplication between pairs of corresponding remainders are independent and can be performed in parallel. In the present application, it is proposed to use the RNS to enable a hardware-efficient reconfigurable support for matrix multiplication with the integrated support for different integer types, including int64, int32 and int16.

A common solution to support various integer types is to add dedicated multiply accumulator (MAC) units for each size. An advantage of the solution is that it can perform calculations of various integer types and sizes in parallel. When only large (e.g., HPC) or small size (e.g., AI) integer calculations are required, hardware efficiency cannot be improved by equipping a dedicated MAC for each size. A similar idea that supports multi-size computing is to use smaller multiplication\ to create larger one. Many ways can be used to build a D×D multiplier by

$$4 \times \frac{D}{2} \times \frac{D}{2}$$

multipliers. Implementation of 64-bit multiplication via 4×32-bit multiplications increases 17-20% of additional hardware and consumes 23-25% of power compared with dedicated 64-bit multiplication. The typical implementation of a dedicated 64-bit multiplier is 3.2-3.9 times larger than the area of a 32-bit multiplier, and in order to implement a 64-bit multiplier, an additional 128-bit accumulator is required. A reconfigurable multi-size feature by splitting D×D multiplier into

$$4 \times \frac{D}{2} \times \frac{D}{2}$$

multipliers requires a final value to be fully reconstructed as result of a multiplication operation, which has a significant additional cost in the hardware.

In view of this, a system for matrix multiplication is proposed, and the proposed system provides a multi-size matrix integer multiplication support without increasing hardware area and implements better power consumption compared with regular 64-bit integer matrix multiplication.

The present application proposes to use a residue independent computation feature of the RNS in order to provide the multi-size support for the matrix multiplication. A main idea of the proposed solution by the present application is to split 64-bit multiplication into 16 modular multiplications, which has a set of advantages. The proposed solution is supposed to be used in a system for matrix multiplication hardware by switching all multiplication and accumulation operations to the RNS. While switching to the RNS requires additional forward conversion and reverse conversion costs, in the case of the matrix multiplication, it is ignored because the number of conversion operations is one order of magnitude less than the number of multiplication and addition.

The following describes the proposed solution of the present application.

FIG. 1 is a schematic block diagram of a system for multi-size support matrix multiplication according to the present application. As shown in FIG. 1, a system (100) includes a forward conversion unit (110), a modular arithmetic unit (120) and a reverse conversion unit (130). The forward conversion unit (110) is configured to receive binary values of input matrices A, B, and perform a forward conversion on the binary values to obtain converted values, that is, perform a binary number system (BNS) to a RNS conversion. Additionally, the forward conversion unit (110) interprets an input value differently depending on an input control signal of the system (100). In this application, a 64-bit input value is interpreted by the forward conversion unit (110) as a single 64-bit value, two 32-bit values or four 16-bit values according to a value of the control signal (expressed by a control signal value in the following embodiments). For example, if the control signal value is equal to 0, the 64-bit input value is interpreted to a single 64-bit value, or if the control signal value is equal to 1, the 64-bit input value is interpreted to two 32-bit values, or if the control signal value is equal to 2, the 64-bit input value is interpreted to four 16-bit values. The forward conversion unit (110) outputs the converted values to the modular arithmetic unit (120). The modular arithmetic unit (120) performs a modular arithmetic operation on the converted values to obtain an operation result based on the control signal. For the matrix multiplication, the modular arithmetic operation includes modular multiplication and modular accumulation. The modular arithmetic unit (120) outputs the operation result to the reverse conversion unit (130). The reverse conversion unit (130) is configured to perform a reverse conversion on the operation result according to the control signal value and Chinese Remainder Theorem (CRT) to reconstruct binary output values of an output matrix C. Specifically, the reverse conversion is a conversion from the RNS to the BNS. In the proposed solution, all of the multiplication and accumulation operations are performed in the RNS.

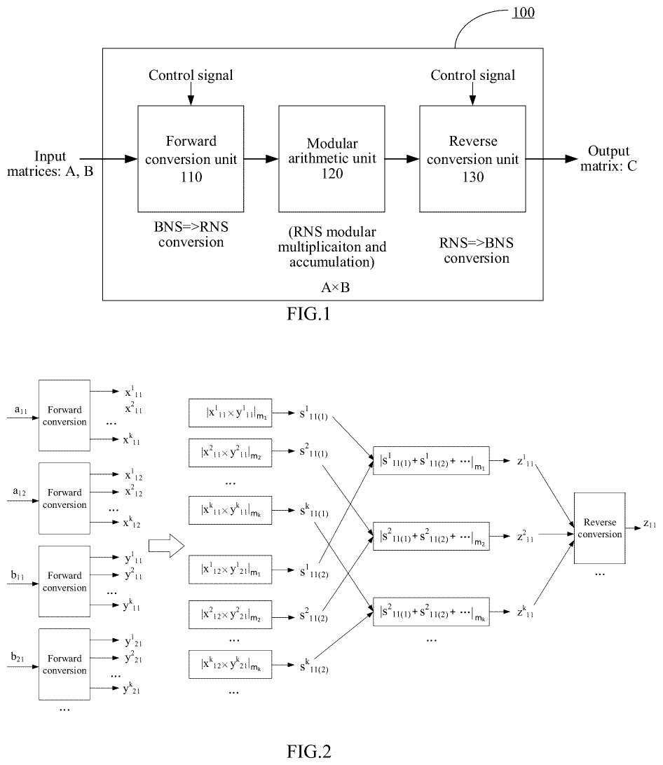

FIG. 2 is an example of a RNS basic flow. As shown in FIG. 2, in RNS, a value is converted into k residues by performing a modular arithmetic operation on the value based on a set of k moduli. After a forward conversion, binary arithmetic operations could be converted into arithmetic operations under the RNS. For a residue number system which has a set of moduli {m₁, m₂, . . . , mₖ)}, for input matrices A and B, binary values aᵢⱼ and bᵢⱼ representing matrix elements satisfying a dynamic range can be represented as {x¹ᵢⱼ, x²ᵢⱼ, . . . , x^{k}ᵢⱼ} and {y¹ᵢⱼ, y²ᵢⱼ, . . . , y^{k}ᵢⱼ}, 1≤(i,j)≤n, respectively. During matrix multiplication, elements of matrix A are first multiplied to elements of matrix B: sᵢⱼ₍ₚ₎=xᵢₚ×yₚⱼ=(<xᵢₚ¹×yₚⱼ¹>m₁, <xᵢₚ²×yₚⱼ²>m₂, . . . , xᵢₚ^{k}×yₚⱼ^{k}>mₖ), and when an operation result Z also satisfies the dynamic range, elements of resulting matrix Z can be represented as k residues: zᵢⱼ=(<Σₚ₌₁ⁿ sᵢⱼ₍ₚ₎¹>m₁, <Σₚ₌₁ⁿsᵢⱼ₍ₚ₎²>m₂, . . . , >Σₚ₌₁ⁿ sᵢⱼ₍ₚ₎^{k}>mₖ), 1≤(i,j)≤n, which then converted to binary value.

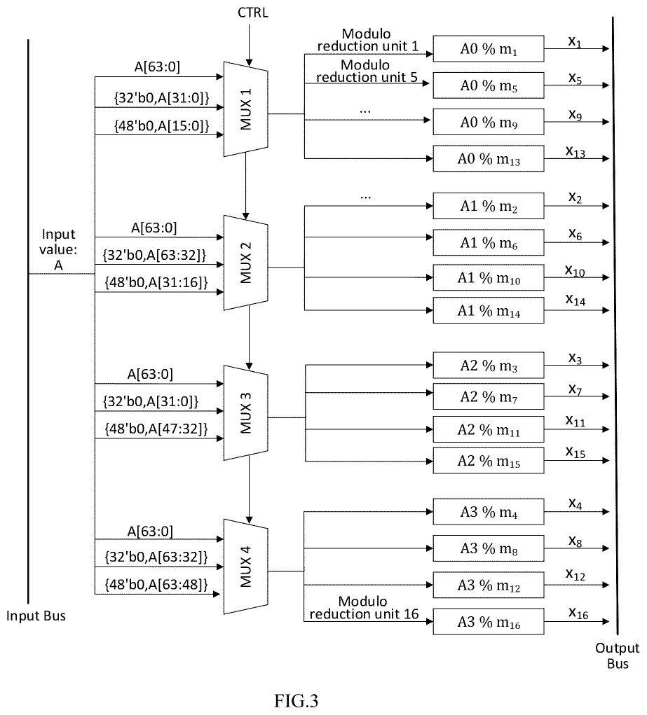

FIG. 3 is a schematic structural diagram of a forward conversion unit according to the present application. As shown in FIG. 3, a forward conversion unit includes four multiplexers and four modulo reduction unit groups, where each modulo reduction unit group includes four modulo reduction units, so the four modulo reduction unit groups include sixteen modulo reduction units in all. As shown in FIG. 3, the four multiplexers are MUX 1, MUX2, MUX3 and MUX4, respectively, and the sixteen modulo reduction units are modulo reduction unit 1, modulo reduction unit 5, . . . , and modulo reduction unit 16, respectively. The sixteen modulo reduction units are in one-to-one correspondence with sixteen moduli provided by the present application, and a set of the sixteen moduli are represented as {m₁, m₂, . . . , M₁₆}.

An input value A (64 bits) represents a single 64-bit value, or two 32-bit values or four 16-bit values depending on a control signal (as CTRL shown in FIG. 3) value. Examples are given as follows:

$$CTRL = 0 , \qquad ( 1 )$$

the input value A represents a single 64-bit value, which is represented here as A[63:0];

$$CTRL = 1 , \qquad ( 2 )$$

the input value A represents two 32-bit values, which is represented here as {A[63:32], A[31:0]};

$$CTRL = 2 , \qquad ( 3 )$$

the input value A represents four 16-bit values, which is represented here as {A[63:48], A[47:32], A[31:16], A[15:0]}.

It should be understood that, if the input value represents two 32-bit values, the two 32-bit values are low 32 bits and high 32 bits of the input value (64 bits), respectively, and if the input value represents four 16-bit values, the four 16-bit values are four segments of the input value (64 bits), respectively, and each of the four segments includes 16 bits. In addition, A is an example of an input value, actually, there are a large of input values of two matrices that need to be performed matrix multiplication.

As shown in FIG. 3, the forward conversion is based on four multiplexers, which provide the appropriate inputs for the sixteen modulo reduction units based on the CTRL signal value. Four groups of modulo reduction units make reduction for the 64-bit input value.

An example of the set of the sixteen moduli {m₁, m₂, . . . , M₁₆} is given below.

Consider that the following set of pairwise co-prime moduli m₁=512, m₂=511, m₃=509, m₄=489, m₅=487, m₆=485, m₇=481, m₈=479, m₉=473, m₁₀=467, m₁₁=431, m₁₂=167, m₁₃=151, m₁₄=139, m₁₅=137, m₁₆=131 has the following features:

$${\prod }_{i = 1}^{16} {m}_{i} > {2}^{128} ; \qquad ( 1 )$$

$$512 \times 509 \times 487 \times 481 \times 473 \times 431 \times 151 \times 137 > {2}^{64} ; \qquad ( 2 )$$

$$511 \times 489 \times 485 \times 479 \times 467 \times 167 \times 139 \times 131 > {2}^{64} ; \qquad ( 3 )$$

$$512 \times 487 \times 473 \times 151 > {2}^{32} ; \qquad ( 4 )$$

$$509 \times 481 \times 431 \times 137 > {2}^{32} ; \qquad ( 5 )$$

$$511 \times 485 \times 467 \times 139 > {2}^{32} ; \qquad ( 6 )$$

$$489 \times 479 \times 167 \times 131 > {2}^{32} \qquad ( 7 )$$

Therefore, the entire set of moduli can be used for 64-bit multiplication. When CTRL=0, all the sixteen modulo reduction units will get A. In this case, outputs of the four multiplexers, that is, A₀[63:0], A₁[63:0], A₂[63:0] and A₃[63:0], are the same, that is, A.

Two subsets of the moduli can be used for 32-bit multiplication, that is, a first subset is represented as {m₁, m₃, m₅, m₇, m₉, m₁₁, m₁₃, m₁₅}=[512, 509, 487, 481, 473, 431, 151, 137] and a second subset is represented as {m₂, m₄, m₆, m₈, m₁₀, m₁₂, m₁₄, m₁₆}=[511, 489, 485, 479, 467, 167, 139, 131]. When CTRL=1, the first subset is handled by the first and the third multiplexer, both of them will return low 32 bits of the input value A, and the second subset is handled by the second and the fourth multiplexer, both of them will return high 32 bits of the input value A. In this case, the first and the third group will get A[31:0], and the second and the fourth group will get A[63:32].

Four subsets of the moduli can be used for 16-bit multiplication, that is, {m₁, m₅, m₉, m₁₃ }=[512, 487, 473, 151], {m₃, m₇, m₁₁, m₁₅ }=[509, 481, 431, 137], {m₂, m₆, m₁₀, m₁₄}=[511, 485, 467, 139], {m₄, m₈, m₁₂, m₁₄}=[489, 479, 167, 131]. When CTRL=2, each multiplexer will return corresponding 16 bits of the input value A, and each group of modulo reduction units will process a single 16-bit value. In this case, the first group will get A[15:0], the second group will get A[31:16], the third group will get A[47:32], and the fourth group will get A[63:48].

In the above different cases, the modulo reduction units perform a modulo reduction operation on values received from the corresponding multiplexer to obtain converted values in the RNS corresponding to input values. It should be noted that the converted values actually are RNS residues of the input values.

For example, when CTRL=0, the input value is a single 64-bit value, and each modulo reduction unit gets the single 64-bit value, and then process the single 64-bit value based on corresponding modulo, respectively. A modulo reduction unit 1 performs the modulo reduction operation on the single 64-bit value based on a modulo corresponding to the modulo reduction unit 1, that is m₁, and modulo reduction unit 5 performs the modulo reduction operation on the single 64-bit value based on a modulo corresponding to a modulo reduction unit 5, that is m₅, and so on. The sixteen modulo reduction units will return sixteen residues, that is {x₁, x₂, x₃, . . . , x₁₆} shown in FIG. 3.

When CTRL=1, the input value is two 32-bit values, the modulo reduction units of the first and the third group will get low 32 bits of the input value, which is called a first 32-bit value, and modulo reduction units of the second and the fourth group will get high 32 bits of the input value, which is called a second 32-bit value. The modulo reduction units of the first and the third group process the first 32-bit value based on the corresponding moduli, respectively. Specifically, each modulo reduction unit of the first and the third group performs a modulo reduction operation on the first 32-bit value based on corresponding modulo to obtain a corresponding residue. Each modulo reduction unit of the second and the fourth group performs the modulo reduction operation on the second 32-bit value based on the corresponding modulo to obtain the corresponding residue. As a result, the first 32-bit value is converted into a set of residues in the RNS by a set of the moduli {m₁, m₅, m₉, m₁₃, m₃, m₇, m₁₁, m₁₅}, where the set of the residues is {x₁, X₅, X₉, x¹³, x₂, x₆, x₁₀, x₁₄}, and the second 32-bit value is also converted into a set of residues in the RNS by the set of moduli {m₂, m₆, m₁, m₁₄, m₄, m₈, m₁₂, m₁₆}, where the set of the residues is {x₂, x₆, x₁₀, x₁₄, x₄, x₈, x₁₂, x₁₆}.

When CTRL=2, the input value is four 16-bit values. Each group of modulo reduction units will get a corresponding single 16-bit value, and then process the single 16-bit value. Specifically, the first group performs the modulo reduction operation by a set of modulo, that is {m₁, m₅, m₉, m₁₃}, to obtain a set of residues, that is {x₁, x₅, x₉, x₁₃}, and the second group performs the modulo reduction operation by a set of modulo, that is {m₃, m₇, m₁₁, m₁₅}, to obtain a set of residues, that is, {x₃, x₇, x₁₁, x₁₅}, and so on.

In addition, in FIG. 3, “32′b0” or “48′b0” is from Verilog notation, “32′b0” means “32 bits with 0”, and “48′b0” means “48 bits with 0”. The first multiplexer is taken as an example, {32′b0, A[31:0]} means the 64-bit input value is performed only for the least significant 32 bits, that is, the low 32 bits of the 64-bit input value, and the most significant 32 bits of the 64-bit input value are regarded as zero by the first multiplexer (as shown in MUX1). Another example is as follows, {48′b0, A[15:0]} means the 64-bit input value is performed only for the least significant 16 bits, and the most significant 48 bits of the 64-bit input value are regarded as zero by the first multiplexer. “32′b0” or “48′b0” corresponding to the other multiplexers has the similar meaning, which can be understood by those skilled in the art according to above examples, and is not explained here one by one.

Independent of an operation mode (a CTRL signal), a delay of the forward conversion will remain unchanged. This is mainly because all the modulo reduction units work with 64-bit input values independently on CTRL signal value. When only 16 bits are supposed to be converted, the most significant bits are just filled by 0.

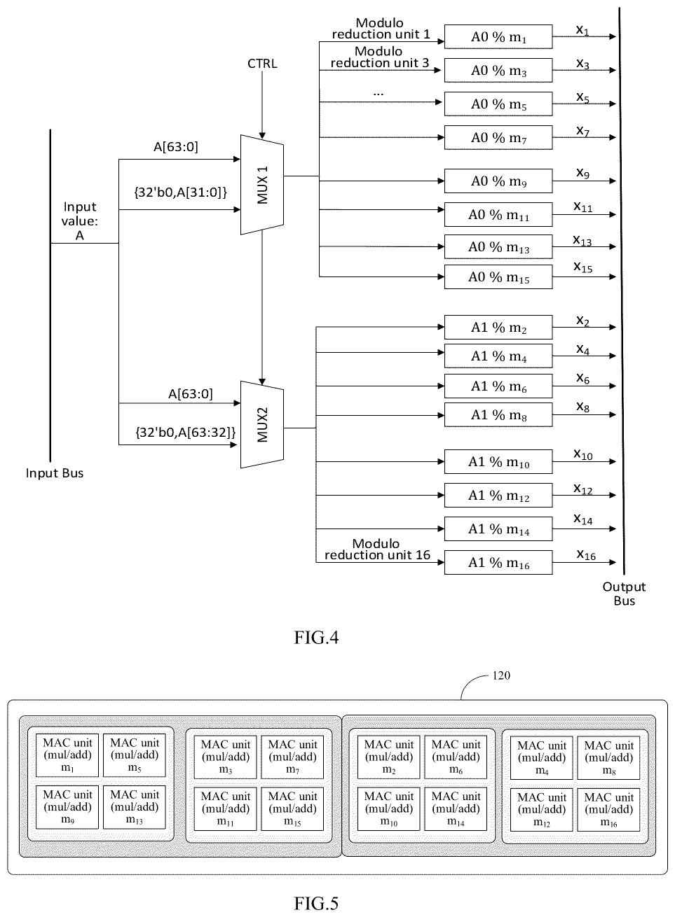

It should be understand that, the architecture shown in FIG. 3 is only an example of the forward conversion unit, and the architecture is applied in the case that the system supports 64-bit size type, 32-bit size type and 16-bit size type. As another example, based on the set of the 16 moduli listed above of the present application, if only 64-bit size type and 32-bit size type are supported, the architecture of the forward conversion unit may be as shown in FIG. 4.

FIG. 4 is an example of forward conversion unit of the present application. It can be found in FIG. 4 that the forward conversion unit includes two multiplexers, that is, MUX 1 and MUX 2. Control signals indicate 64-bit size type or 32-bit size type. In the case that the control signal indicates a 64-bit size type, both the MUX 1 and MUX 2 get the input value A, and input value A will be inputted into modulo reduction unit groups corresponding to MUX 1 and MUX 2 respectively. In this case, A0=A1. In the case that the control signal indicates a 32-bit size type, the input value A will be interpreted as two 32-bit values, and MUX 1 gets the high 32 bits of the input value, and the MUX 2 gets the lower 32 bits of the input value. The high 32 bits of the input value will be inputted into the modulo reduction unit group corresponding to the MUX 1, and low 32 bits of the input value will be inputted into the modulo reduction unit group corresponding to the MUX 2. It can be seen that, in this example, MUX 1 and MUX 2 are in correspondence with two modulo reduction unit groups as shown in FIG. 4, where each modulo reduction unit group includes 8 modulo reduction units. The 16 modulo reduction units are in one to one correspondence with 16 moduli of the RNS proposed by the present application.

Other structures of the system proposed by the present application will be described below by taking the architecture shown in FIG. 3 as an example of the forward conversion unit.

FIG. 5 is a schematic structural diagram of a modular arithmetic unit according to the present application. As shown in FIG. 5, a modular arithmetic unit includes sixteen multiply accumulator (MAC) units, and the sixteen MAC units are in one-to-one correspondence with sixteen moduli, i.e., {m₁, m₂, . . . , m₁₆}, provide by the present application. Each MAC unit includes a modulo adder and a modulo multiplier. Since a modulo operation can be executed independently, no additional multi-size support is required in the MAC unit except a dedicated mode (in other words, a dedicated signal) for 8-bit addition and multiplication, which should bypass reduction. The sixteen MAC units are implicitly grouped based on a control signal processing a single 64-bit value, or two 32-bit values or four 16-bit values.

It should be understood that, each modulo multiplier makes a calculation of zᵢ=|xᵢ×yᵢ|mᵢ, and each modulo adder makes a calculation of zᵢ|xᵢ+yᵢ|mᵢ, where 1≤i≤16, and i is an integer. Here, xᵢ is a i-th residue of a residue set of an element value of a matrix A, and yᵢ is a i-th residue of an element value of a matrix B.

The sixteen MAC units are implicitly grouped based on the control signal value, processing the single 64-bit value, or two 32-bit values or four 16-bit values. For example, if CTRL=0, the sixteen MAC units form a group, and process the single 64-bit value, and if CTRL=1, the sixteen MAC units form two groups, one of the two groups includes eight MAC units corresponding to 8 moduli, that is, m₁, m₅, m₉, m₁₃, m₃, m₇, m₁₁, and m₁₅, and the other group includes eight MAC units corresponding to the other 8 moduli, that is, m₂, m₆, m₁₀, m₁₄, m₄, m₈, m₁₂ and m₁₆.

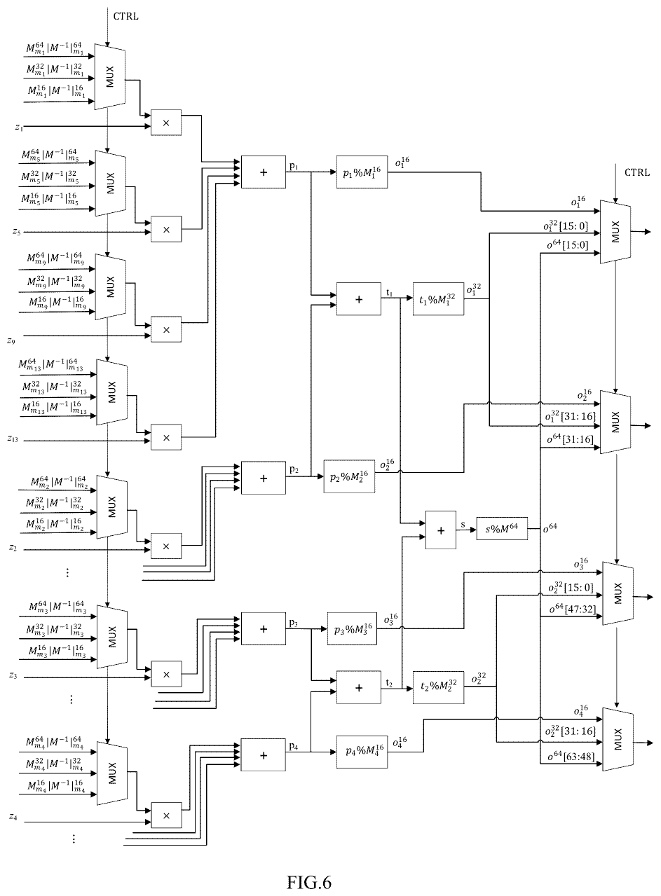

FIG. 6 is a schematic structural diagram of a reverse conversion according to the present application. As shown in FIG. 6, such structure represents a reconstruction mechanism of a single 64-bit value, or two 32-bit values or four 16-bit binary values from RNS using the CRT:z=||Σᵢ₌₁^{k} zᵢ MᵢMᵢ⁻¹||_{M},

$$M = {\prod }_{i = 1}^{k} {m}_{i} , {M}_{i} = \frac{M}{{m}_{i}} , {\vert {M}_{i} {M}_{i}^{- 1} \vert}_{{m}_{i}} = 1$$

according to a control signal. Inputs for a reverse conversion unit are arithmetic operation results zᵢ, which are first multiplied by a pre-computed constant MᵢMᵢ⁻¹, and the constant is different for each modulo and CTRL signal value. The CRT for reverse conversion is merely taken as an example. The diagram of FIG. 6 shows how to enable multi-size support using CRT. However, the present application probably may not be limited to the CRT method for reverse conversion since other methods, such as extended CRT (EXCRT) or Mixed-Radix Conversion (MRC), can also be used to enable multi-size support.

Specifically, as shown in FIG. 6, the reverse conversion unit includes a first multiplexer set and a second multiplexer set. The first multiplexer set includes sixteen multiplexers, where the sixteen multiplexers are in one-to-one correspondence with sixteen MAC units, and the sixteen multiplexers are divided into four groups, and each group includes four multiplexers. The sixteen multiplexers are configured to receive a control signal, and return a pre-computed constant value from three pre-computed constant values.

The reverse conversion unit further includes a multiplier set, and the multiplier set includes sixteen multipliers, where the sixteen multipliers are in one-to-one correspondence with the sixteen multiplexers, and the sixteen multipliers are in one-to-one correspondence with the sixteen MAC units. Each multiplier of the sixteen multipliers contained in the multiplier set is configured to perform a multiplication operation on an output of the corresponding multiplexers and an output of the corresponding MAC unit.

The reverse conversion unit further includes three adder sets. A first adder set of the three adder sets includes four adders, where the four adders are in one-to-one correspondence with the four multiplexer groups, and an input of each adder of the four adders includes outputs of four multipliers corresponding to the four multiplexer groups.

A second adder set of the three adder sets includes two adders, where a first adder of the two adders is configured to receive an output of a first adder and an output of a second adder contained in the first adder set, and a second adder of the two adders is configured to receive an output of a third adder and an output of a fourth adder contained in the first adder set.

A third adder set of the three adder sets includes an adder, where the adder is configured to receive outputs of the two adders contained in the second adder set.

The second multiplexer set includes four multiplexers, where an input of each multiplexer is an operation result by performing a modulo reduction operation on outputs of the four adders contained in the first adder set, or outputs of the two adders contained in the second adder set, or an output of the adder contained in the third adder set.

The four multiplexers included in the second multiplexer set are configured to receive the control signal, and determine a corresponding output value according to the control signal value.

As shown in FIG. 6, each multiplexer contained in the first multiplexer set will return a corresponding constant value, then each zᵢ is multiplied by a constant, resulting in products being accumulated in groups by four moduli. A result of accumulation moves towards in the following directions:
(1) If CTRL=2 (represents 16-bit values), reduction by a corresponding constant value Mⱼ¹⁶, 1≤j≤4 is applied on the result of the accumulation, and this leads to a final 32-bit value;
(2) If CTRL=1 (represents 32-bit values), it is accumulated with the neighboring group sum of products and then reduced by a corresponding constant value Mⱼ³², 1≤j≤2, and this leads to a final 64-bit value;
(3) All the group sum of products are accumulated and then reduced by value M=Πᵢ₌₁^{k}mᵢ, this leads to a final 128-bit value.

The final set of multiplexers (that is, the second multiplexer set) forms correct output values according to a CTRL signal value, that is, the single 128-bit value, or two 64-bit values or four 32-bit output values.

It can be seen from FIG. 6 that the three pre-computed constant values of the i-th multiplexer of the first multiplexer set are Mₘ_{ᵢ}⁶⁴|M⁻¹|ₘ_{ᵢ}⁶⁴, Mₘ_{ᵢ}³²|M⁻¹|ₘ_{ᵢ}³² and Mₘ_{ᵢ}¹⁶|M⁻¹|ₘ_{ᵢ}¹⁶, 1≤i≤16 and i is a positive integer. The i-th multiplexer is specifically configured to output Mₘ_{ᵢ}⁶⁴|M⁻¹|ₘ_{ᵢ}⁶⁴ if the control signal value is equal to the first value, or output Mₘ_{ᵢ}³²|M⁻¹|ₘ_{ᵢ}³² if the control signal value equals to the second value, or output Mₘ_{ᵢ}¹⁶|M₋₁|ₘ_{ᵢ}¹⁶ if the control signal value is equal to the third value. As stated above, the three pre-computed constant values of the i-th multiplexer of the sixteen multiplexers are Mₘ_{ᵢ}⁶⁴|M⁻¹|ₘ_{ᵢ}⁶⁴, Mₘ_{ᵢ}³²|M⁻¹|ₘ_{ᵢ}³² and Mₘ_{ᵢ}¹⁶|M⁻¹|ₘ_{ᵢ}¹⁶, actually, the three pre-computed constant values of the i-th multiplexer are M⁶⁴|M⁻¹|⁶⁴, Mⱼ³²|M⁻¹| and Mⱼ¹⁶|M⁻¹|ⱼ¹⁶, respectively, where for Mⱼ³²|M⁻¹|ⱼ³², j is equal to 1 for m₁, m₅, m₉, m₁₃, m₃, m₇, m₁₁, or m₁₅, and j is equal to 2 for m₂, m₆, m₁₀, m₁₄, m₄, m₈, m₁₂, or m₁₆; for Mⱼ¹⁶|M⁻¹|ⱼ¹⁶, j is equal to 1 for m₁, m₅, m₉ or m₁₃; j is equals to 2 for m₂, m₆, m₁₀ or m₁₄; j is equal to 3 for m₃, m₇, m₁₁, m₁₅; and j is equal to 4 for m₄, m₈, m₁₂, m₁₆. That is, the subscript of the three pre-computed constant values relates to the corresponding group of modulo. For example, for 64-bit input type, there should be no subscript at all, that is, Mₘ_{ᵢ}⁶⁴|M⁻¹|ₘ_{ᵢ}⁶⁴, is actually M⁶⁴|M⁻¹|ₘ_{ᵢ}⁶⁴. For 32-bit input type, the subscript can be 1 or 2, that is, Mₘ_{ᵢ}³²|M⁻¹|ₘ_{ᵢ}³² is actually M₁³¹|M⁻¹|₁³² or M₂³²|M⁻¹|₂³², and a value of the subscript depends on the group of modulo to which the mᵢ belongs. It has been known that, there are two groups of modulo for 32-bit input type, since m₁, m₅, m₉, m₁₃, m₃, m₇, m₁₁, or m₁₅ belongs to a first group of modulo, for m₁, m₅, m₉, m₁₃, m₃, m₇, m₁₁, or m₁₅, Mₘ_{ᵢ}³²|M⁻¹|ₘ_{ᵢ}³² is M₁³²|M⁻¹|₁³² and m₂, m₆, m₁₀, m₁₄, m₄, m₅, m₁₂, or m₁₆ belongs to a second group of modulo, for m₂, m₆, m₁₀, m₁₄, m₄, m₅, m₁₂, or m₁₆, Mₘ_{ᵢ}³²|M⁻¹|ₘ_{ᵢ}³² is M₂³²|M⁻¹|₂³². For 16-bit input type, the subscript can be 1, 2, 3 or 4, that is, Mₘ_{ᵢ}¹⁶|M⁻¹|ₘ_{ᵢ}¹⁶ is actually M₁¹⁶|M⁻¹|₁¹⁶, M₂¹⁶|M⁻¹|₂¹⁶, M₃¹⁶|M⁻¹|₃¹⁶ or M₄¹⁶|M⁻¹|₄¹⁶, and the value of the subscript depends on the group of modulo to which the mᵢ belongs. There are four groups of modulo for 16-bit input type, {m₁, m₅, m₉, m₁₃}, {m₂, m₆, m₁₀, m₁₄}, {m₃, m₇, m₁₁, m₁₅} and {m₄, m₅, m₁₂, m₁₆} are in one-to-one correspondence with the four groups, hence, for m₁, m₅, m₉ or m₁₃, Mₘ_{ᵢ}¹⁶|M⁻¹|ₘ_{ᵢ}¹⁶ is M₁¹⁶|M⁻¹|₁¹⁶, for m₂, m₆, m₁₀ or m₁₄, Mₘ_{ᵢ}¹⁶|M⁻¹ₘ_{ᵢ}¹⁶ is M₂¹⁶|M⁻¹|₂¹⁶, for m₃, m₇, m₁₁ or m₁₅, Mₘ_{ᵢ}¹⁶|M⁻¹|ₘ_{ᵢ}¹⁶ is M₃¹⁶|M⁻¹|₃¹⁶, and for m₄, m₅, m₁₂, m₁₆, Mₘ_{ᵢ}¹⁶|M⁻¹|ₘ_{ᵢ}¹⁶ is M₄¹⁶|M⁻¹|₄¹⁶.

The four multiplexers contained in the second multiplexer set are specifically configured as follows:
if the control signal value is equal to the first value, an output of each of the four multiplexers is an operation result on an output of the adder contained in the third adder set by performing a modulo reduction operation, that is, s % M⁶⁴, where s is the output of the adder contained in the third adders set, M⁶⁴=Πᵢ₌₁¹⁶ mᵢ, here M⁶⁴ means “M for 64-bit input type”, the outputs of the four multiplexers are four segments of the modulo reduction operation result (“modulo reduction result” for short somewhere), and the four segments are o⁶⁴[15:0], o⁶⁴[31:16], o⁶⁴ [47:32], o⁶⁴[63:48], respectively;
if the control signal value is equal to the second value, outputs of a first multiplexer and a second multiplexer of the four multiplexers are operation results by performing the modulo reduction operation, that is t₁% M₁³², on an output of a first adder contained in the second adder set, where t₁ is the output of the first adder contained in the second adder set, M₁³²=m₁×m₅×m₉×m₁₃×m₃×m₇×m₁₁×m₁₅, here M₁³² means “M for 32-bit input type”, the subscript (1) of M₁³² relates to a first modulo group for 32-bit input type, and the outputs of the first multiplexer and the second multiplexer of the four multiplexers are two segments of the modulo reduction operation results, and the two segments are o₁³² [15:0], o₁³² [31:16], respectively. Outputs of a third multiplexer and a fourth multiplexer are operation results by performing the modulo reduction operation, that is, t₂% M₂, on an output of a second adder contained in the second adder set, where t₂ is the output of the second adder contained in the second adder set, M₂³²=m₂×m₆×m₁₀×m₁₄×m₄×m₈×m₁₂×m₁₆, here M₂³² means “M for 32-bit input type”, and the subscript (2) of M₂³² relates to a second modulo group for 32-bit input type. The outputs of the third multiplexer and the fourth multiplexer of the four multiplexers are two segments of the modulo reduction operation results, and the two segments are o₂³²[15:0], o₂³²[31:16], respectively;
if the control signal value is equal to the third value, an output of a j-th multiplexer of the four multiplexers is a modulo reduction operation result by performing the modulo reduction operation, that is, pⱼ% Mⱼ¹⁶, on an output of the j-th adder contained in the first adder set, where pⱼ is the output of the j-th adder, M₁¹⁶=m₁×m₅×m₉×m₁₃, M₂¹⁶=m₂×m₆×m₁₀×m₁₄, M₃¹⁶=m₃×m₇×m₁₁×m₁₅, M₄¹⁶=m₄×m₈×m₁₂×m₁₆ 1≤j≤4 and j is an integer, here Mⱼ¹⁶ means “M for 16-bit input type”, and the subscript (j) of Mⱼ¹⁶ relates to a first, second, third or fourth modulo group for 16-bit input type. The outputs of the four multiplexers are o₁¹⁶, o₂¹⁶, o₃¹⁶, o₄¹⁶, respectively.

Alternatively, an output matrix will have 2× larger size type for the elements, which can be configured to properly handle overflows or implement fixed-point data types.

This application has the following advantages:
(1) The same set of t modular multipliers and adders can be configured to enable a single 64-bit, two 32-bit, four 16-bit and sixteen 8-bit MAC units by grouping moduli properly.
(2) Hardware area and power consumption of sixteen 8-bit/9-bit modular multipliers (need to fully cover [0, 2¹²⁸−1] binary range) is less than area and power consumption of a single 64-bit multiplier due to complex carry propagation logic for 64-bit adders and multipliers.

There is no any dedicated multi-size support needed in the modular multipliers except dedicated handling of 8-bit multiplication, which can simply disable modular reduction in the present application. The logic of other size types is fully handled by RNS to BNS/BNS to RNS converters. A separate control signal is added to the converters to maintain all possible input/output types that a matrix multiplier can handle. Depending on the control signal value, an input 64-bit value can be interpreted as 1×64-bit value, or 2×32-bit values, or 4×16-bit values or 16×8-bit values.

A RNS forward conversion is implemented in a way to find a residue for 64-bit value for each modulo, this logic can be fully configured for different size types to deal with 64-bit input values, and it needs to simply expand the smaller size. The latency of forward conversion for all the integer size types will remain the same. A proper grouping of moduli is defined architecturally and fixed in the hardware. For 8-bit input type, forward conversion is simply bypassed.

Reverse conversion is based on hierarchical accumulation of intermediate values, where 64-bit size type requires the accumulation across all the layers, while 32-bit size type avoids the last level of the accumulation, 16-bit size type avoids the last two levels of the accumulation, and 8-bit size type bypass the reverse conversion.

Forward conversion and reverse conversion take more area and higher power consumption than modulo multipliers, however, they are only needed to convert all the values of input matrices and convert values of output matrix back. For a n×n matrix, the number of forward converters needed is 2×n², and the number of reverse converters needed is n², while assuming that the matrix is multiplied in one cycle, a total number of the modular arithmetic units is n³, which allows all costs of forward/reverse conversion to be hidden under the benefits of small modular multipliers. If a matrix multiplication hardware accelerator operates with a single row and a single column in one cycle, a ratio between converters and the modular arithmetic units will remain the same, that is, 2×n forward converters, n reverse converters, and the total number of the modular arithmetic units is n².

RNS multipliers (for the whole modulo set converting [0, 2128−1] range) can be implemented by occupying 40% less in area than a single 64-bit multiplier and consuming 50% less power. Assuming hardware area is occupied by 64×64 multiplier and its power consumption is 1, then we can build the following table with the costs of RNS based matrix multiplication (all the numbers below are results of actual experiments using the best known algorithms for forward/reverse conversion and modulo reduction).

TABLE 1

| | Hardware area | Power consumption |
|---|---|---|
| RNS multiplier | 0.6 | 0.5 |
| RNS forward conversion | 0.7 | 0.5 |
| RNS reverse conversion | 1.6 | 1.7 |

Therefore, a RNS matrix multiplication area is 2×0.7n²+0.6n³+1.6n² versus

$$\frac{1.4 + 0.6 n + 1.6}{n} = n ( 0.6 + \frac{3}{n} ) .$$

When n=8, the RNS matrix multiplication area is 0.975 of 64×64 matrix multiplication area. When n=16, the RNS matrix multiplication area is 0.79 of 64×64 matrix multiplication area.

RNS matrix multiplication power consumption is 2×0.5n²+0.5n³+1.7n² versus

$${n}^{3} : n ( 0.5 + \frac{2.2}{n} ) .$$

When n=8, the RNS matrix multiplication power consumption is 0.775 of 64×64 matrix multiplication power consumption. When n=16, the RNS matrix multiplication power consumption is 0.64 of 64×64 matrix multiplication power consumption. It should be noted that these numbers can differ depending on actual technique process.

Accordingly, this application also provides a method for matrix multiplication.

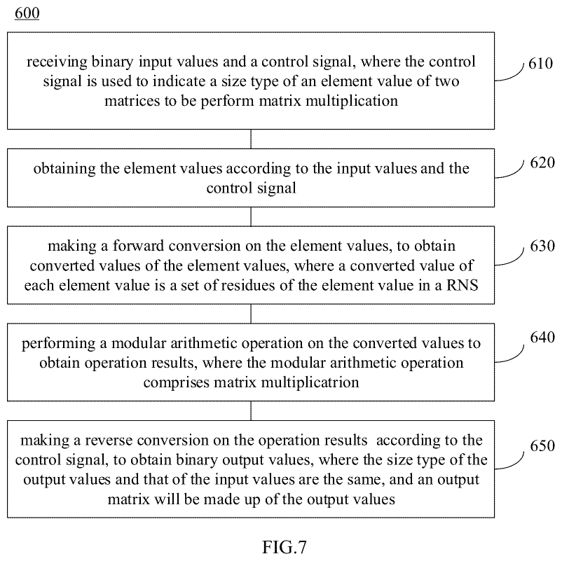

FIG. 7 shows a schematic diagram of a method for matrix multiplication according to the present application. The method can be performed by a system for matrix multiplication proposed by the present application. A method (600) specifically includes the following steps:

Step 610: receiving binary input values and a control signal, where the control signal is configured to indicate a size type of the element values of two matrices performing matrix multiplication.

As an example, the size type includes one of the following types: a 64-bit type, a 32-bit type or a 16-bit type.

Step 620: obtaining the element values according to the input values and the control signal, for example, obtaining the element values by determining each input value as a single 64-bit element value in case of a control signal value is equal to a first value, or obtaining the element values by splitting each input value into two 32-bit element values in case of a control signal value is equal to a second value, or obtaining the element values by splitting each input value into four 16-bit element values in case of a control signal value is equal to a third value.

Step 630: making a forward conversion on the element values to obtain converted values of the element values, where a converted value of each element value is a set of residues of the element value in a residue number system (RNS).

Step 640: performing a modular arithmetic operation on the converted values to obtain operation results, where the modular arithmetic operation includes matrix multiplication.

Step 650: making a reverse conversion on the operation results according to the control signal to obtain binary output values, where the output values and the input values have the same size type, and an output matrix will consist of the output values.

As an example, the system makes the reverse conversion on the operation results by using the Chinese remainder theorem (CRT), EXCRT or MRC according to the control signal to obtain binary output values.

All related contents of steps in a method embodiment have been described in detail in the foregoing system embodiment, and in order to avoid repetition, details are not repeated here.

The present application also provides a chip or chip system including a plurality of circuits, and the plurality of circuits are configured to have functions of units included in a system for matrix multiplication as provided in the present application.

In the several embodiments provided in this application, it should be understood that the disclosed system and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A system for matrix multiplication, comprising a forward conversion unit, a modular arithmetic unit and a reverse conversion unit,
wherein the forward conversion unit is configured to:
receive binary input values and a control signal, wherein the control signal is configured to indicate a size type of the input values;
make a forward conversion on the input values according to the size type to obtain converted values of the input values, wherein a converted value of each input value is a set of residues of the input value in a residue number system (RNS); and
output the converted values to the modular arithmetic unit;
wherein the modular arithmetic unit is configured to:
receive the converted values from the forward conversion unit;
perform a modular arithmetic operation on the converted values according to a set of moduli of the RNS to obtain operation results; and
output the operation results to the reverse conversion unit;
wherein the reverse conversion unit is configured to:
receive the operation results and the control signal;
make a reverse conversion on the operation results according to the control signal to obtain the binary output values, wherein the binary output values and the binary input values have the same size type.

2. The system according to claim 1, the forward conversion unit comprises M multiplexers which corresponds to M modulo reduction unit groups, wherein the system supports value processing of multiple size types, the multiple size types comprise a first size type and a second size type, and the first size type corresponds to a maximum size that supported by the system;
in the case that the control signal indicates the first size type, M multiplexers obtain each of the binary input values as an input of the corresponding modulo reduction unit groups respectively;
or
in the case that the control signal indicates the second size type, the M multiplexers obtain part bits of each of the binary input values as an input of the corresponding modulo reduction unit groups respectively, M is an integer greater than or equal to 2.

3. The system according to claim 2, each of the M modulo reduction unit groups comprises P modulo reduction units, P is an integer greater than or equal to 2.

4. The system according to claim 2, wherein the forward conversion unit comprises four multiplexers and four modulo reduction unit groups, the four multiplexers are in one-to-one correspondence with the four modulo reduction unit groups; each of the four modulo reduction unit groups comprises four modulo reduction units, and the four modulo reduction unit groups comprise sixteen modulo reduction units in all, wherein the sixteen modulo reduction units are in one-to-one correspondence with sixteen moduli of the RNS;
wherein the four multiplexers are specifically configured to:
receive the control signal;
determine the size type of the input values as a 64-bit type in case of a value of the control signal being equal to a first value;
obtain the input values, and output each input value to each of the sixteen modulo reduction units; and
wherein the sixteen modulo reduction units are specifically configured to:
perform a reduction operation on each input value to obtain sixteen converted values based on their corresponding moduli respectively, wherein each of the sixteen modulo reduction units obtains one converted value of the sixteen converted values.

5. The system according to claim 4, wherein determine the size type of the input values as a 32-bit type in case of a value of the control signal being equal to a second value;
wherein a first multiplexer and a third multiplexer of the four multiplexers obtain low 32 bits of each input value respectively, the first multiplexer outputs the low 32 bits to a corresponding first modulo reduction unit group, and the third multiplexer outputs the low 32 bits to a corresponding third modulo reduction unit group;
wherein a second multiplexer and a fourth multiplexer of the four multiplexer obtain high 32 bits of each input value respectively, the second multiplexer outputs the high 32 bits to a corresponding second modulo reduction unit group, and the fourth multiplexer outputs the high 32 bits to a corresponding fourth modulo reduction unit group; and
wherein the four modulo reduction units are specifically configured as follows:
the first modulo reduction unit group and the third modulo reduction unit group perform a modulo reduction operation on the low 32 bits to obtain four converted values, respectively, based on four moduli corresponding to the four modulo reduction units contained in each of the first modulo reduction unit group and the third modulo reduction unit group, respectively; and
the second modulo reduction unit group and the fourth modulo reduction unit group perform a modulo reduction operation on the high 32 bits to obtain four converted values, respectively, based on four moduli corresponding to the four modulo reduction units contained in each of the second modulo reduction unit group and the fourth modulo reduction unit group, respectively.

6. The system according to claim 5, wherein each of the four multiplexers is specifically configured to:
receive the control signal;
determine the size type of the input values as a 16-bit type in case of a value of the control signal being equal to a third value;
obtain one of four segments constituting each input value, and output the obtained segment to a corresponding modulo reduction unit group, respectively; and
wherein each of the modulo reduction unit groups is specifically configured to:
perform a modulo reduction operation on the corresponding segment, respectively, based on four moduli corresponding to the four modulo reduction units contained in each of the four modulo reduction unit groups, to obtain four converted values, respectively.

7. The system according to claim 4, wherein the modular arithmetic unit comprises sixteen multiply accumulator (MAC) units, the sixteen MAC units are in one-to-one correspondence with the sixteen moduli, and the sixteen MAC units are in one-to-one correspondence with the sixteen modulo reduction units;
wherein each of the sixteen MAC units is specifically configured to:
receive converted values from a corresponding modulo reduction unit, and perform modulo multiplication and a modulo accumulation operation on each converted value to obtain a corresponding operation result; and
wherein when performing the modulo multiplication and the modulo accumulation operation, the sixteen MAC units form different groups in the following way:
the sixteen MAC units form one group in case of the size type of the input values being 64-bit type, wherein the group is configured to perform the modulo multiplication and the modulo accumulation operation on the sixteen converted values from the sixteen modulo reduction units, and output sixteen operation results corresponding to the sixteen converted values; or
the sixteen MAC units form two groups in case of the size type of the input values being 32-bit type, wherein each of the two groups comprises eight MAC units, one of the two groups is configured to perform the modulo multiplication and the modulo accumulation operation on eight converted values and output eight operation results corresponding to the eight converted values, and the eight converted values comprise the four converted values from the first modulo reduction unit and the third modulo reduction unit, respectively; wherein the other of the two groups is configured to perform the modulo multiplication and the modulo accumulation operation on the other eight converted values and output eight operation results corresponding to the other eight converted values, and the other eight converted values comprise the four converted values from the second modulo reduction unit and the fourth modulo reduction unit, respectively; or
the sixteen MAC units form four groups in case of the size type of the input values being 16-bit type, wherein each of the four groups comprises four MAC units, the four groups are in one-to-one correspondence with the four modulo reduction unit groups, and each of the four groups is configured to perform the modulo multiplication and the modulo accumulation operation on the four converted values from the four modulo reduction units contained in the corresponding modulo reduction group and output four operation results corresponding to the four converted values, respectively.

8. The system according to claim 2, wherein the reverse conversion unit supports reverse conversion of multiple size types, and the multiple size types further include a third size type, and the third size type corresponds to the minimum size supported by the system;
the reverse conversion unit includes a first multiplexer set containing M P multiplexers and a second multiplexer set containing V multiplexers, the M P multiplexers are in one-to-one correspondence with M P operation results from the modular arithmetic unit respectively, and the V multiplexers are used for outputting the binary output values;
in the case that the value of the control signal indicates the first size type, each of the V multiplexers obtains a segment of a modulo reduction result related to all of the M P operation results as an output respectively, and V segments corresponding to the V multiplexers reconstruct an binary output value corresponding to the first size type;
or,
in the case that the value of the control signal indicates the third size type, each of the V multiplexers obtains an modulo reduction result related to P operation results of the M P operation results as an output, and the modulo reduction result obtained by each of the multiplexers reconstructs an binary output value corresponding to the third size type;
or,
in the case that the value of the control signal indicates the second size type, each of the V multiplexers obtains a modulo reduction result related to L operation results of the M P operation results as an output, and the modulo reduction result obtained by each of the V multiplexers is a segment of an binary output corresponding to the second size type, L is an integral multiple of P.

9. The system according to claim 8, wherein the first multiplexer set comprises sixteen multiplexers, and the sixteen multiplexers are in one-to-one correspondence with the sixteen MAC units, wherein the sixteen multiplexers are four multiplexer groups, and each of the four multiplexer groups comprises the four multiplexers;
wherein the sixteen multiplexers contained in the first multiplexer set are respectively configured to receive the control signal, and return a constant value from three pre-computed constant values according to the control signal, respectively;
wherein the reverse conversion unit further comprises a multiplier set, the multiplier set comprises sixteen multipliers, the sixteen multipliers are in one-to-one correspondence with the sixteen multiplexers contained in the first multiplexer set, and the sixteen multipliers are in one-to-one correspondence with the sixteen MAC units; wherein each of the sixteen multipliers is configured to perform a multiplication operation on an output of a corresponding multiplier of the sixteen multipliers and an output of a corresponding MAC unit of the sixteen MAC units, and output a corresponding operation result;
wherein the reverse conversion unit further comprises three adder sets, a first adder set of the three adder sets comprises four adders, wherein the four adders are in one-to-one correspondence with the four multiplexer groups, and an input of each adder of the four adders comprises outputs of four multipliers corresponding to the four multiplexers in the corresponding multiplexer group;
a second adder set of the three adder sets comprises two adders, wherein a first adder of the two adders is configured to receive an output of the first adder and an output of the second adder contained in the first adder set, and a second adder of the two adders is configured to receive an output of the third adder and an output of the fourth adder contained in the first adder set;
a third adder set of the three adder sets comprises one adder, wherein the adder is configured to receive outputs of the two adders contained in the second adder set;
wherein the second multiplexer set comprises the four multiplexers, and an input of each multiplexer contained in the four multiplexers is obtained by performing the modulo reduction operation on outputs of the four adders contained in the first adder set, an input of each multiplexer contained in the four multiplexers is obtained by performing the modulo reduction operation on the outputs of the two adders contained in the second adder set, or an input of each multiplexer contained in the four multiplexers is obtained by performing the modulo reduction operation on an output of the adder contained in the third adder set; and
wherein the four multiplexers contained in the second multiplexer set are configured to receive the control signal and determine a corresponding output value according to the control signal.

10. The system according to claim 9, wherein the pre-computed three constant values of a i-th multiplexer of the sixteen multiplexers contained in the first multiplexer set comprise: Mₘ_{ᵢ}⁶⁴|M⁻¹|ₘ_{ᵢ}⁶⁴, Mₘ_{ᵢ}³²|M⁻¹|ₘ_{ᵢ}³², and Mₘ_{ᵢ}¹⁶|M⁻¹|ₘ_{ᵢ}¹⁶, wherein 1≤i≤16 and i is a positive integer;
wherein the i-th multiplexer is specifically configured to:
output Mₘ_{ᵢ}⁶⁴|M⁻¹|ₘ_{ᵢ}⁶⁴ in case of the value of the control signal being equal to the first value;
output Mₘ_{ᵢ}³²|M⁻¹|ₘ_{ᵢ}³² in case of the value of the control signal being equal to the second value; and
output Mₘ_{ᵢ}¹⁶|M⁻¹|ₘ_{ᵢ}¹⁶, in case of the value of the control signal being equal to the third value.

11. The system according to claim 2, a set of the sixteen moduli of the RNS is {m₁, m₂, . . . , M₁₆}, wherein the sixteen moduli meet the following criteria:
$${\prod }_{i = 1}^{16} {m}_{i} > {2}^{128 -} ; \qquad ( 1 )$$
$${m}_{1} \times {m}_{5} \times {m}_{9} \times {m}_{13} \times {m}_{3} \times {m}_{7} \times {m}_{11} \times {m}_{15} > {2}^{64} ; \qquad ( 2 )$$
$${m}_{2} \times {m}_{6} \times {m}_{10} \times {m}_{14} \times {m}_{4} \times {m}_{8} \times {m}_{12} \times {m}_{16} > {2}^{64} ; \qquad ( 3 )$$
$${m}_{1} \times {m}_{5} \times {m}_{9} \times {m}_{13} > {2}^{32} ; \qquad ( 4 )$$
$${m}_{2} \times {m}_{6} \times {m}_{10} \times {m}_{14} > {2}^{32} ; \qquad ( 5 )$$
$${m}_{3} \times {m}_{7} \times {m}_{11} \times {m}_{15} > {2}^{32} ; \qquad ( 6 )$$
$${m}_{4} \times {m}_{8} \times {m}_{12} \times {m}_{16} > {2}^{32} . \qquad ( 7 )$$

12. The system according to claim 11, wherein the four modulo reduction unit groups are in one-to-one correspondence with four modulo groups consisting of the sixteen moduli, and the four modulo groups are: {m₁, m₅, m₉, m₁₃}, {m₂, m₆, m₁₀, m₁₄}, {m₃, m₇, m₁₁, m₁₅}, and {m₄, m₅, m₁₂, m₁₆}, wherein {m₁, m₂, . . . , m₁₆}={512, 511, 509, 489, 487, 485, 481, 479, 473, 467, 431, 167, 151, 139, 137, 131}.

13. The system according to claim 11, wherein the four multiplexers contained in the second multiplexer set are specifically configured as follows:
in case of the value of the control signal being equal to the first value, an output of each of the four multiplexers is an operation result by performing a modulo reduction operation s % M⁶⁴ on the output of the adder contained in the third adder set, wherein s is the output of the adder contained in the third adder set, M⁶⁴=Πᵢ₌₁¹⁶ₘ_{ᵢ}, and outputs of the four multiplexers are four segments of the operation result, respectively, wherein the four segments are o⁶⁴[15:0], o⁶⁴[31:16], O⁶⁴[47:32], o⁶⁴[63:48].

14. The system according to claim 11, wherein the four multiplexers contained in the second multiplexer set are specifically configured as follows:
in case of the value of the control signal being equal to the second value, outputs of a first multiplexer and a second multiplexer of the four multiplexers are operation results by performing a modulo reduction operation t₁% M₁³² on an output of the first adder contained in the second adder set, wherein t₁ is the output of the first adder contained in the second adder set, M₁³²=m₁×m₅×m₉×m₁₃×m₃×m₇×m₁₁×m₁₅, and the outputs of the first multiplexer and the second multiplexer are two segments of the operation results, respectively, wherein the two segments are o³²[15:0], o³²[31:16]; and
outputs of a third multiplexer and a forth multiplexer of the four multiplexers are operation results by performing a modulo reduction operation t₂% M₂³² on an output of the second adder contained in the second adder set, wherein t₂ is the output of the second adder contained in the second adder set, M₂³²=m₂×m₆×m₁₀×m₁₄×m₄×m₈×m₁₂×m₁₆, and the outputs of the third multiplexer and the fourth multiplexer are two segments of the operation results, wherein the two segments are o³² [15:0], o³² [63:16].

15. The system according to claim 11, wherein the four multiplexers comprised in the second multiplexer set are specifically configured to:
in case of the value of the control signal equals to the third value, an output of the j-th multiplexer of the four multiplexer is an operation result by performing a modulo reduction operation pⱼ% Mⱼ¹⁶ on an output of the j-th adder comprised in the first adder set, wherein pⱼ is the output of the j-th adder, M₁¹⁶=m₁×m₅×m₉×m₁₃, M₂¹⁶=m₂×m₆×m₁₀×m₁₄, M₃¹⁶=m₃×m₇×m₁₁×m₁₅, M₄¹⁶=m₄×m₈×m₁₂×m₁₆, 1≤j≤4 and j is an integer, and outputs of the four multiplexer are respectively o₁¹⁶, o₂¹⁶, o₃¹⁶, o₄¹⁶.

16. A method for matrix multiplication, comprising:
receiving binary input values and a control signal, wherein the control signal is configured to indicate a size type of element values of two matrices to be performed matrix multiplication;
obtaining the element values according to the input values and the control signal;
making a forward conversion on the element values to obtain converted values of the element values, wherein a converted value of each element value is a set of residues of the element value in a residue number system (RNS);
performing a modular arithmetic operation on the converted values according to a set of moduli of the RNS to obtain operation results, wherein the modular arithmetic operation comprises the matrix multiplication; and
making a reverse conversion on the operation results according to the control signal to obtain binary output values, wherein the output values and the input values have the same size type, and an output matrix will consist of the output values.

17. The method according to claim 16, wherein the obtaining the element values according to the input values and the control signal further comprises:
obtaining the element values by determining each input value as a single 64-bit element value in case of a value of the control signal being equal to a first value;
obtaining the element values by splitting each input value into two 32-bit element values in case of the value of the control signal being equal to a second value; or
obtaining the element values by splitting each input value into four 16-bit element values in case of the value of the control signal being equal to a third value.

18. The method according to claim 16, wherein a set of sixteen moduli of the RNS is {m₁, m₂, . . . , M₁₆}, and the sixteen moduli meet the following criteria:
$${\prod }_{i = 1}^{16} {m}_{i} > {2}^{128 -} ; \qquad ( 1 )$$
$${m}_{1} \times {m}_{5} \times {m}_{9} \times {m}_{13} \times {m}_{3} \times {m}_{7} \times {m}_{11} \times {m}_{15} > {2}^{64} ; \qquad ( 2 )$$
$${m}_{2} \times {m}_{6} \times {m}_{10} \times {m}_{14} \times {m}_{4} \times {m}_{8} \times {m}_{12} \times {m}_{16} > {2}^{64} ; \qquad ( 3 )$$
$${m}_{1} \times {m}_{5} \times {m}_{9} \times {m}_{13} > {2}^{32} ; \qquad ( 4 )$$
$${m}_{2} \times {m}_{6} \times {m}_{10} \times {m}_{14} > {2}^{32} ; \qquad ( 5 )$$
$${m}_{3} \times {m}_{7} \times {m}_{11} \times {m}_{15} > {2}^{32} ; \qquad ( 6 )$$
$${m}_{4} \times {m}_{8} \times {m}_{12} \times {m}_{16} > {2}^{32} . \qquad ( 7 )$$
